(19) United States
(12) Patent Application Publication
(10) Pub. No.: US 2026/0063204 A1
(43) Pub. Date: Mar. 5, 2026

(54) SEALING STRUCTURE FOR COMPRESSED AIR ENERGY STORAGE (CAES) DEVICE AND CONSTRUCTION METHOD

(71) Applicant: CHINA UNIVERSITY OF GEOSCIENCES (WUHAN), Wuhan (CN)

(72) Inventors: Guohua ZHANG, Wuhan (CN); Yuchen SUN, Wuhan (CN); Dongjie HUA, Wuhan (CN); Feng XIONG, Wuhan (CN)

(73) Assignee: CHINA UNIVERSITY OF GEOSCIENCES (WUHAN), Wuhan (CN)

(21) Appl. No.: 19/380,381

(22) Filed: Nov. 5, 2025

(30) Foreign Application Priority Data
Nov. 11, 2024 (CN) 202411602064.9

(51) Int. Cl. F16J 15/02; G01M 3/02

(52) U.S. Cl. CPC F16J 15/022; G01M 3/02

(57) ABSTRACT

A sealing structure for a compressed air energy storage device includes: a lining body; a sealing assembly including a supporting frame and a plurality of sealing plates, where the supporting frame is detachably connected to the lining body, and the plurality of sealing plates are disposed on an inner wall of the lining body through the supporting frame, and configured to seal an interior of the lining body; and a monitoring assembly including a plurality of monitoring members, where the plurality of monitoring members are disposed on the inner wall of the lining body, and configured to monitor sealing states of the sealing plates; and the sealing plate is made of a rubber material. The present disclosure solves the problem that in case of an airtight failure of the air storage chamber, the failed position cannot be detected and the failed component cannot be replaced quickly.

### CROSS-REFERENCE TO RELATED APPLICATIONS

This application claims priority to Chinese Patent Application No. 202411602064.9 with a filing date of Nov. 11, 2024. The content of the aforementioned application, including any intervening amendments thereto, is incorporated herein by reference.

### TECHNICAL FIELD

The present disclosure relates to the technical field of new energy storage, and in particular to a sealing structure for a compressed air energy storage (CAES) device and a construction method.

### BACKGROUND

While wind energy, solar energy and other renewable energy account for an increasingly large proportion, their intermittence and instability lead to a significant contradiction between the generated electricity and the actual electricity demand. Due to this supply-demand imbalance, not only the stability of power systems is affected, but also a large amount of clean energy is forced into curtailment during low-demand periods, such as "wind curtailment" and "solar curtailment", and cannot be utilized fully. Hence, in order to improve the utilization rate of the renewable energy, CAES has emerged as a key link in development of modern energy systems.

CAES devices are used to convert excess electrical energy into compressed air, and store it underground or in sealed containers, effectively realizing storage and reuse of the electrical energy. This technology can mitigate the grid load and balance the power demand, and can further realize a quick response in short time to enhance flexibility and stability of the power systems. In this process, design and operation efficiency of air storage chambers are crucial, and are directly associated with overall performance and economy of the systems. Conventional air storage chambers are largely a steel-lined sealing layer structure, with serious resource consumption and large construction difficulty. In case of an airtightness failure of the air storage chambers, failed portions cannot be detected and failed components cannot be replaced quickly.

Therefore, a sealing structure for a CAES device and a construction method are desired to solve the above problems.

### SUMMARY OF PRESENT INVENTION

An objective of the present disclosure is to provide a sealing structure for a CAES device and a construction method, to solve the problem in the prior art.

To achieve the above objective, the present disclosure provides the following technical solutions: The present disclosure provides a sealing structure for a CAES device, including:

a lining body;

a sealing assembly including a supporting frame and a plurality of sealing plates, where the supporting frame is detachably connected to the lining body, and the plurality of sealing plates are disposed on an inner wall of the lining body through the supporting frame, and configured to seal an interior of the lining body; and

a monitoring assembly including a plurality of monitoring members, where the plurality of monitoring members are disposed on the inner wall of the lining body, and configured to monitor sealing states of the sealing plates, where

the plurality of sealing plates are made of a rubber material.

According to the sealing structure for a CAES device provided by the present disclosure, the supporting frame includes:

a plurality of joint supports each detachably connected to the inner wall of the lining body, the plurality of joint supports being arranged in an array;

a plurality of connection supports each detachably connected to the inner wall of the lining body, and located between two adjacent joint supports; and

a plurality of seals disposed on the joint support and the connection support, where the sealing plate is in limited connection with the joint support and the connection support through the seal.

According to the sealing structure for a CAES device provided by the present disclosure, the seal includes:

a first sealing member matching with the joint support, where the first sealing member is detachably connected to the joint support and comes in contact with the sealing plate; and

a second sealing member matching with the connection support, where the second sealing member is detachably connected to the connection support and comes in contact with the sealing plate.

According to the sealing structure for a CAES device provided by the present disclosure, first protrusions are respectively disposed at four corners of the joint support; the joint support defines a cross-shaped groove through the four first protrusions; and the first sealing member matches with the cross-shaped groove.

According to the sealing structure for a CAES device provided by the present disclosure, second protrusions are respectively disposed at two ends of the connection support; the connection support defines a linear groove through the two second protrusions; the second sealing member matches with the linear groove; and the linear groove communicates with the cross-shaped groove.

According to the sealing structure for a CAES device provided by the present disclosure, two adjacent first protrusions on the joint support and the two second protrusions on the connection support define an M-shaped structure.

According to the sealing structure for a CAES device provided by the present disclosure, a sealing ring is fixedly connected to an inner edge of the sealing plate; and the sealing rings are respectively nested in the cross-shaped groove and the linear groove, and come in contact with the first sealing member and the second sealing member, respectively.

According to the sealing structure for a CAES device provided by the present disclosure, the monitoring member includes a reserved hole formed in the inner wall of the lining body; an air pressure sensor is disposed in the reserved hole; and a permeable steel is fixedly connected to the reserved hole.

According to the sealing structure for a CAES device provided by the present disclosure, a steel mesh interlayer is disposed in the sealing plate.

The present disclosure provides a construction method of a sealing structure for a CAES device, including the following steps:

mounting the monitoring member on the inner wall of the lining body;

mounting the supporting frame on the inner wall of the lining body; and

mounting the plurality of sealing plates on the inner wall of the lining body, and connecting the plurality of sealing plates to the supporting frame.

Compared with the prior art, the present disclosure has the following advantages and technical effects:

According to the sealing structure for a CAES device and the construction method provided by the present disclosure, the plurality of monitoring members are mounted on the lining body, the supporting frame is mounted, the sealing plates are mounted, and the plurality of sealing plates are connected to the supporting frame for sealing. Through the plurality of monitoring members, sealing on positions of the plurality of sealing plates is monitored. When an airtightness failure is detected, a failed position is accurately located, and the corresponding sealing plate is replaced conveniently. The sealing layer made of the rubber material has a lower cost than the conventional steel-lined sealing layer, accounting for 8% of the cost of the air storage chamber. The present disclosure can be adapted to mounting environments of the air storage chamber in different environments, and features the light weight and crossed construction. While the sealing layer can be mounted in a short construction period, the air storage chamber has prolonged single operation time and prolonged service life. With real-time monitoring on each rubber sealing layer and targeted location on the leakage point, the present disclosure can realize the timely feedback to the airtightness failed portion, effectively solving the problem that the airtightness failure of the conventional air storage chamber cannot be handled. The present disclosure realizes and implements the adhesive-free modular crimping process. When the air pressure sensor feeds back the local airtightness failure, the present disclosure can quickly detach, check and mount the sealing plate on the failed portion, namely perform modular replacement. The adhesive-free modular construction method for the rubber sealing layer greatly mitigates the construction resource consumption, and greatly facilitates subsequent monitoring, repair and replacement of the air storage chamber.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is an overall schematic structural view according to the present disclosure;

FIG. 2 is a schematic structural view of a lining body according to the present disclosure;

FIG. 3 is a schematic structural view of a monitoring member according to the present disclosure;

FIG. 4 is a schematic structural view of a joint support according to the present disclosure;

FIG. 5 is a schematic structural view of a connection support according to the present disclosure;

FIG. 6 is a schematic structural view of a supporting frame according to the present disclosure;

FIG. 7 is a schematic view of a mounting state of a supporting frame according to the present disclosure;

FIG. 8 is a schematic structural view of a sealing plate according to the present disclosure;

FIG. 9 is a schematic view of a connected state between a sealing plate and a joint support according to the present disclosure;

FIG. 10 is a schematic view of a connected state of a sealing plate with a joint support and a connection support according to the present disclosure;

FIG. 11 is a schematic structural view of a first sealing member according to the present disclosure;

FIG. 12 is a schematic structural view of a second sealing member according to the present disclosure; and

FIG. 13 is a schematic structural view of a sealing structure according to the present disclosure.

In the figures: 1: lining body, 2: sealing plate, 3: joint support, 4: connection support, 5: first sealing member, 6: second sealing member, 7: first protrusion, 8: second protrusion, 9: reserved hole, 10: air pressure sensor, 11: permeable steel, 12: steel mesh interlayer, 13: threaded hole, 14: mounting hole, 15: bolt, and 16: gasket.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure clearer and more comprehensible, the present disclosure will be further described in detail below with reference to the accompanying drawings and the specific examples.

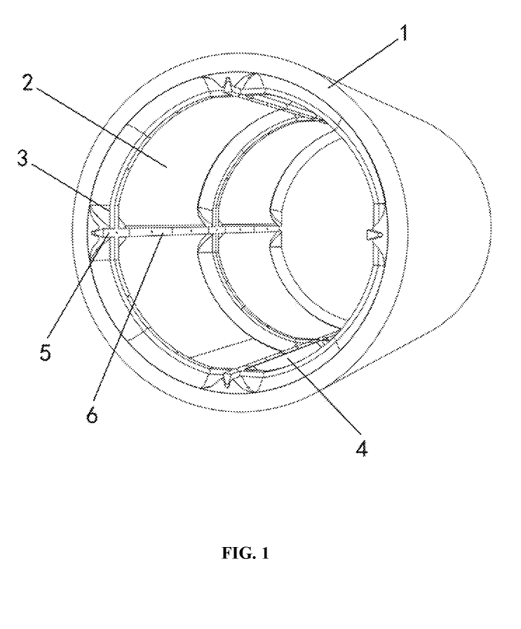

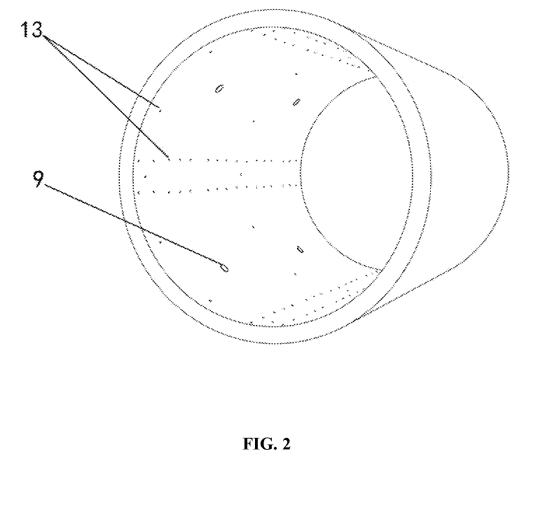

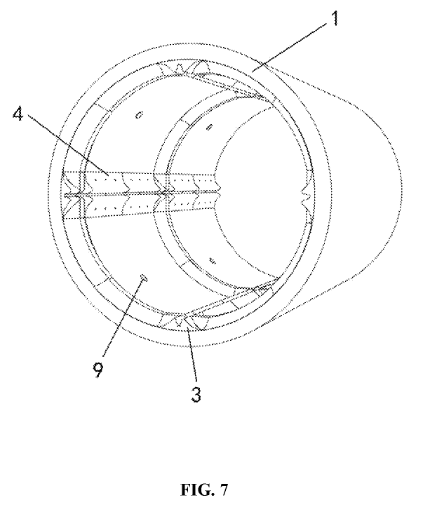

Referring to FIGS. 1-13, the present disclosure provides a sealing structure for a CAES device, including:

a lining body 1, a sealing assembly, and a monitoring assembly.

The sealing assembly includes a supporting frame and a plurality of sealing plates 2. The supporting frame is detachably connected to the lining body 1. The plurality of sealing plates 2 are disposed on an inner wall of the lining body 1 through the supporting frame, and configured to seal an interior of the lining body 1.

The monitoring assembly includes a plurality of monitoring members. The plurality of monitoring members are disposed on the inner wall of the lining body 1, and configured to monitor sealing states of the sealing plates 2.

The sealing plate 2 is made of a rubber material.

Specifically, the plurality of monitoring members are mounted on the lining body 1, the supporting frame is mounted, the sealing plates 2 are mounted, and the plurality of sealing plates 2 are connected to the supporting frame to realize sealing and ensuring a sealing effect. Through the plurality of monitoring members, sealing on positions of the plurality of sealing plates 2 is monitored. When an airtight failure is detected, a failed position is accurately located, and the corresponding sealing plate 2 is replaced conveniently.

As an optional implementation, the supporting frame includes: a plurality of joint supports 3, a plurality of connection supports 4, and a plurality of seals.

The plurality of joint supports 3 each are detachably connected to the inner wall of the lining body 1. The plurality of joint supports 3 are arranged in an array.

The plurality of connection supports 4 each are detachably connected to the inner wall of the lining body 1, and located between two adjacent joint supports 3.

The plurality of seals are disposed on the joint support 3 and the connection support 4. The sealing plate 2 is in limited connection with the joint support 3 and the connection support 4 through the seal.

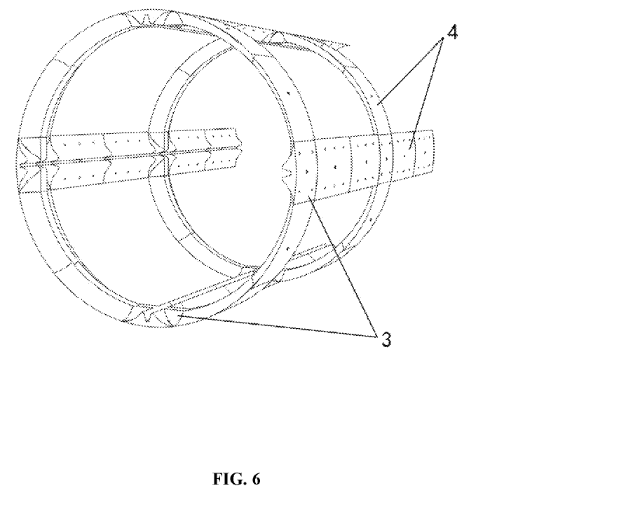

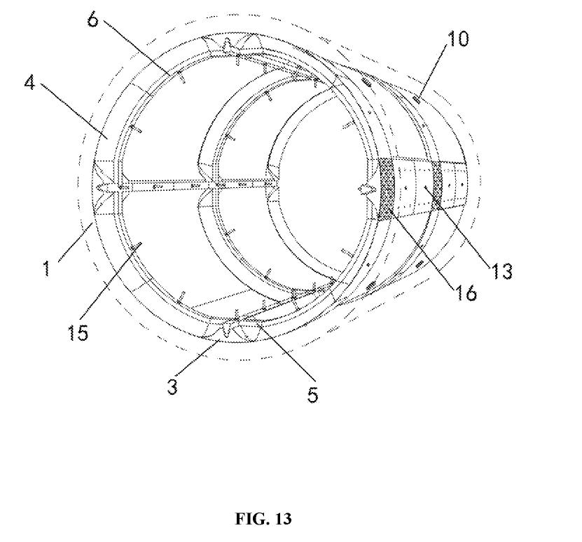

In an implementation of the present disclosure, referring to FIG. 1, FIG. 6 and FIG. 13, a plurality of threaded holes 13 are formed in the lining body 1. Through the threaded hole 13 and a bolt 15, the joint support 3 and the connection support 4 are assembled and disposed on the lining body 1.

Specifically, a gasket 16 is further disposed between each of the joint support 3 and the connection support 4 and the lining body 1, and configured to ensure airtightness at a junction.

As an optional implementation, the seal includes: a first sealing member 5 and a second sealing member 6.

The first sealing member 5 matches with the joint support 3. The first sealing member 5 is detachably connected to the joint support 3 and comes in contact with the sealing plate 2.

The second sealing member 6 matches with the connection support 4. The second sealing member 6 is detachably connected to the connection support 4 and comes in contact with the sealing plate 2.

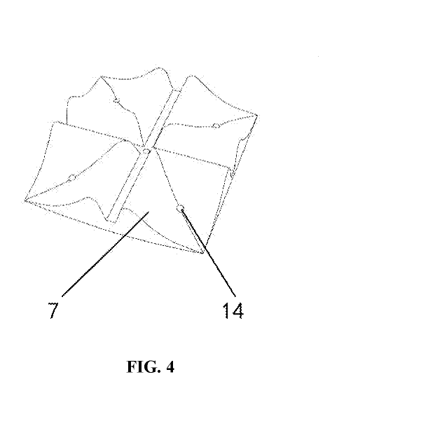

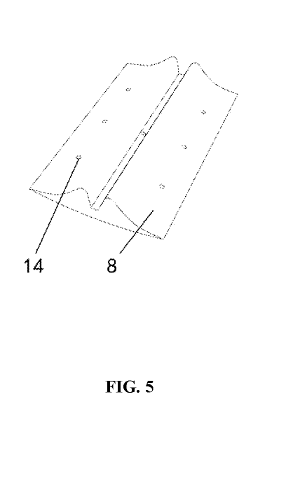

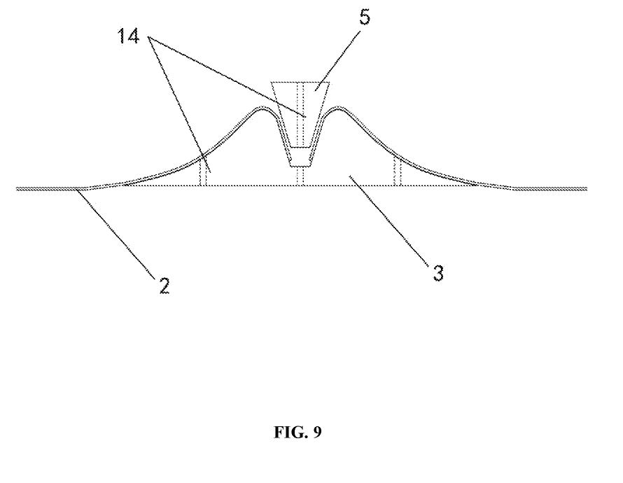

In an implementation of the present disclosure, referring to FIG. 1, FIG. 4, FIG. 5, FIG. 9 and FIG. 13, the sealing plate 2 is disposed on the joint support 3 and the connection support 4, and the first sealing member 5 and the second sealing member 6 are respectively disposed on the joint support 3 and the connection support 4, realizing stable connection of the sealing plate 2.

Specifically, mounting holes 14 are respectively formed in the joint support 3, the connection support 4, the first sealing member 5 and the second sealing member 6, and configured to connect the joint support 3, the connection support 4, the first sealing member 5 and the second sealing member 6.

As an optional implementation, first protrusions 7 are respectively disposed at four corners of the joint support 3. The joint support 3 defines a cross-shaped groove through the four first protrusions 7. The first sealing member 5 matches with the cross-shaped groove.

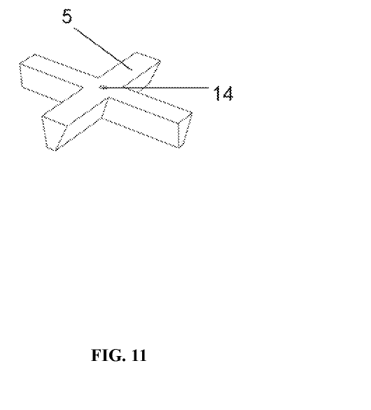

In an implementation of the present disclosure, referring to FIG. 4 and FIG. 11, the first sealing member 5 matches with the cross-shaped groove, with a bottom being a wedge-shaped structure, and is configured to squeeze an end of the sealing plate 2 extended into the cross-shaped groove into the cross-shaped groove, thereby ensuring the sealing effect.

As an optional implementation, second protrusions 8 are respectively disposed at two ends of the connection support 4. The connection support 4 defines a linear groove through the two second protrusions 8. The second sealing member 6 matches with the linear groove. The linear groove communicates with the cross-shaped groove.

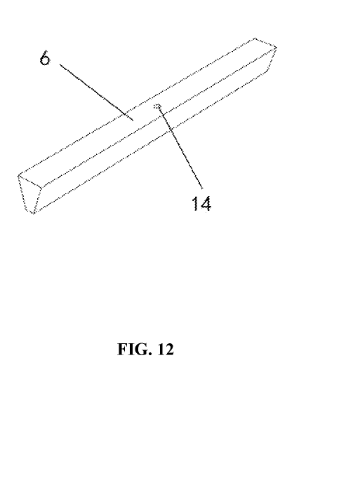

In an implementation of the present disclosure, referring to FIG. 5 and FIG. 12, the second sealing member 6 matches with the linear groove, with a bottom being a wedge-shaped structure, and is configured to squeeze an end of the sealing plate 2 extended into the linear groove into the linear groove, thereby ensuring the sealing effect. Through a wedge-shaped member and a bolt, the sealing plate 2 is tightly attached to an inner groove of each support, forming an intact and reliable novel adhesive-free modular structure.

As an optional implementation, two adjacent first protrusions 7 on the joint support 3 and the two second protrusions 8 on the connection support 4 define an M-shaped structure.

In an implementation of the present disclosure, referring to FIG. 4 and FIG. 5, four sides of the joint support 3 each are an M-shaped structure. A section of the connection support 4 is an M-shaped structure. The joint support 3 and the connection support 4 are symmetric in contact surface.

As an optional implementation, a sealing ring is fixedly connected to an inner edge of the sealing plate 2. The sealing rings are respectively nested in the cross-shaped groove and the linear groove, and come in contact with the first sealing member 5 and the second sealing member 6, respectively.

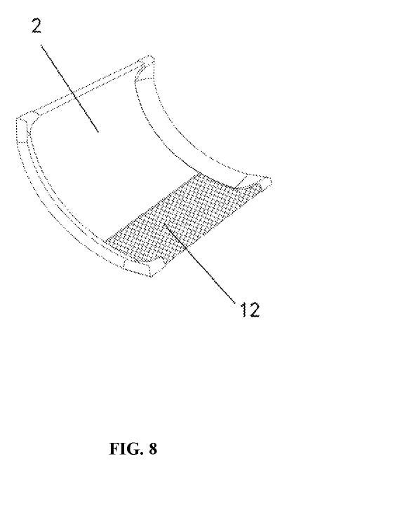

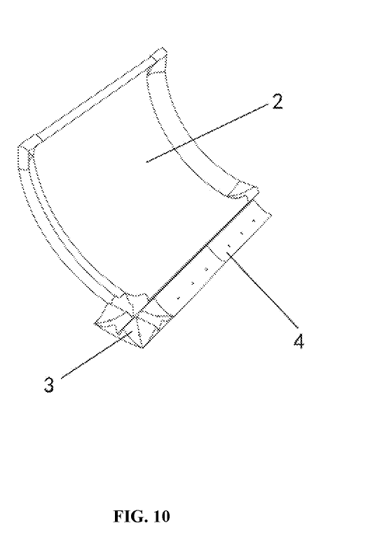

In an implementation of the present disclosure, referring to FIG. 8, FIG. 9 and FIG. 10, by providing a sealing ring structure on the sealing plate 2, sides of the whole sealing plate 2 can be wrapped. The sealing plate 2 is extended into the cross-shaped groove and the linear groove, and squeezed by the first sealing member 5 and the second sealing member 6 for mounting, thereby ensuring the whole sealing effect. When some sealing plate 2 needs to be replaced, it can be detached quickly.

Specifically, the sealing ring structure uses an edge wrapping manner. Hence, when the sealing plate 2 is mounted, a crowbar and other tools are used to snap four wrapped corners of the sealing plate 2 into the special joint supports 3 in sequence. When the wrapped edges are handled, the four edges are snapped into the connecting supports 4. Each joint support 3 is configured to mount connected wrapped corners of four adjacent sealing plates 2. Each connection support 6 is configured to mount connected edges of two adjacent sealing plates 2.

As an optional implementation, the monitoring member includes a reserved hole 9 formed in the inner wall of the lining body 1. An air pressure sensor 10 is disposed in the reserved hole 9. A permeable steel 11 is fixedly connected to the reserved hole 9.

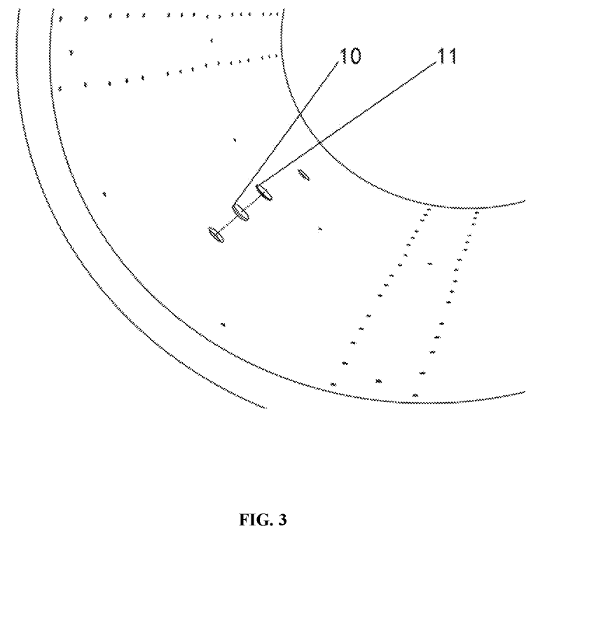

In an implementation of the present disclosure, referring to FIG. 3, the air pressure sensor 10 is configured to monitor a sealing condition of the sealing plate 2. Specifically, the air pressure sensor 10 is preferably a dedicated sensor for an air storage chamber.

Specifically, a plurality of air pressure sensors 10 are in one-to-one correspondence with the plurality of sealing plates 2, and configured to accurately locate an airtightness failed position. Targeted accurate location on the failed position facilitates subsequent replacement.

As an optional implementation, a steel mesh interlayer 12 is disposed in the sealing plate 2.

In an implementation of the present disclosure, referring to FIG. 8, through the steel mesh interlayer 12, a structural strength of the sealing plate 2 is further improved.

The present disclosure provides a construction method of a sealing structure for a CAES device, including the following steps:

The monitoring member is mounted on the inner wall of the lining body 1.

The supporting frame is mounted on the inner wall of the lining body 1.

The plurality of sealing plates 2 are mounted on the inner wall of the lining body 1, and connected to the supporting frame.

During use, the reserved hole 9 for mounting the air pressure sensor 10 and the threaded hole 13 for mounting the bolt 15 are drilled in the pre-constructed lining body 1. Upon completion of drilling operations, the air pressure sensor 10 is mounted in the reserve hole 9, seal-welded with the permeable steel 11, and connected in a wired manner to the air storage chamber to feed back the airtightness. The joint support 3 and the connection support 4 are mounted to the threaded hole 13 with the bolt 15. It is to be noted that when the joint support 3 and the connection support 4 are fixed, the thin gasket 16 is provided between each of the joint support 3 and the connection support 4 and the lining body 1, ensuring airtightness between adjacent components. The sealing plate 2 is bent and mounted in site. During mounting of the sealing layer, the crowbar and other tools are used to snap the four wrapped corners of the sealing plate 2 into the joint supports 3 in sequence. While the wrapped edges are handled, the four edges are snapped into the connecting supports 4, realizing mounting of the sealing plate 2, and ensuring the sealing effect upon the mounting. The corresponding sealing plate 2 is monitored subsequently with the air pressure sensor 10. When necessary, the individual sealing plate 2 may be detached and replacement conveniently.

It should be understood that in the description of the present disclosure, terms such as "longitudinal", "transverse", "upper", "lower", "front", "rear", "left", "right", "vertical", "horizontal", "top", "bottom", "inside" and "outside" indicate the orientation or position relationships based on the drawings. They are merely intended to facilitate description of the present disclosure, rather than to indicate or imply that the mentioned device or elements must have a specific orientation and must be constructed and operated in a specific orientation. Therefore, these terms should not be construed as a limitation to the present disclosure.

The above embodiments are only intended to describe the preferred implementations of the present disclosure, but not to limit the scope of the present disclosure. Various alterations and improvements made by those of ordinary skill in the art based on the technical solution of the present disclosure without departing from the design spirit of the present disclosure shall fall within the scope of the appended claims of the present disclosure.

What is claimed is:

1. A sealing structure for a compressed air energy storage (CAES) device, comprising:
a lining body (1);
a sealing assembly comprising a supporting frame and a plurality of sealing plates (2), wherein the supporting frame is detachably connected to the lining body (1), and the plurality of sealing plates (2) are disposed on an inner wall of the lining body (1) through the supporting frame, and configured to seal an interior of the lining body (1); and
a monitoring assembly comprising a plurality of monitoring members, wherein the plurality of monitoring members are disposed on the inner wall of the lining body (1), and configured to monitor sealing states of the plurality of sealing plates (2), wherein
the plurality of sealing plates (2) are made of a rubber material.

2. The sealing structure according to claim 1, wherein the supporting frame comprises:
a plurality of joint supports (3) each detachably connected to the inner wall of the lining body (1), the plurality of joint supports (3) being arranged in an array;
a plurality of connection supports (4) each detachably connected to the inner wall of the lining body (1), and located between two adjacent joint supports (3); and
a plurality of seals disposed on the plurality of joint supports (3) and the plurality of connection support (4), wherein the plurality of sealing plates (2) are respectively in limited connection with the plurality of joint support (3) and the plurality of connection supports (4) through the plurality of seals.

3. The sealing structure according to claim 2, wherein each of the plurality of seals comprises:
a first sealing member (5) matching with the plurality of joint supports (3), wherein the first sealing member (5) is detachably connected to the plurality of joint supports (3) and comes in contact with the plurality of sealing plates (2); and
a second sealing member (6) matching with the plurality of connection supports (4), wherein the second sealing member (6) is detachably connected to the plurality of connection supports (4) and comes in contact with the plurality of sealing plates (2).

4. The sealing structure according to claim 3, wherein first protrusions (7) are respectively disposed at four corners of each of the plurality of joint supports (3); each joint support (3) defines a cross-shaped groove through the four first protrusions (7); and the first sealing member (5) matches with the cross-shaped groove.

5. The sealing structure according to claim 4, wherein second protrusions (8) are respectively disposed at two ends of each of the plurality connection supports (4); each connection support (4) defines a linear groove through the two second protrusions (8); the second sealing member (6) matches with the linear groove; and the linear groove communicates with the cross-shaped groove.

6. The sealing structure according to claim 5, wherein two adjacent first protrusions (7) on the joint support (3) and the two second protrusions (8) on the connection support (4) define an M-shaped structure.

7. The sealing structure according to claim 5, wherein a sealing ring is fixedly connected to an inner edge of each of the plurality of sealing plates (2); and the sealing ring is respectively nested in the cross-shaped groove and the linear groove, and come in contact with the first sealing member (5) and the second sealing member (6), respectively.

8. The sealing structure according to claim 3, wherein the monitoring member comprises an air pressure sensor (10) disposed in a reserved hole (9) formed in the inner wall of the lining body (1); a permeable steel (11) is fixedly connected to the reserved hole (9).

9. The sealing structure according to claim 1, wherein a steel mesh interlayer (12) is disposed in each of the plurality of sealing plates (2).

10. A construction method of the sealing structure according to claim 1, comprising the following steps:
mounting the monitoring member on the inner wall of the lining body (1);
mounting the supporting frame on the inner wall of the lining body (1); and
mounting the plurality of sealing plates (2) on the inner wall of the lining body (1), and connecting the plurality of sealing plates (2) to the supporting frame.
